(19) United States
(12) Patent Application Publication
(10) Pub. No.: US 2024/0200640 A1
(43) Pub. Date: Jun. 20, 2024

(54) TRANSMISSION MECHANISM AND ENERGY CONVERSION DEVICE HAVING THE SAME

(71) Applicant: Yun-Sheng LIU, New Taipei City (TW)

(72) Inventor: Yun-Sheng LIU, New Taipei City (TW)

(21) Appl. No.: 18/179,296

(22) Filed: Mar. 6, 2023

(30) Foreign Application Priority Data
Dec. 19, 2022 (TW) 111148760

(51) Int. Cl. F16H 19/04; F16H 19/08; F16H 57/023; F16H 57/038; H02K 7/00; H02K 7/116

(52) U.S. Cl. CPC F16H 19/043; F16H 19/08; F16H 57/023; F16H 57/038; H02K 7/003; H02K 7/116

(57) ABSTRACT

A transmission mechanism includes a housing, an input shaft extending through the housing, two first transmission members rotatably sleeved on the input shaft and respectively having a first bevel gear portion, an output shaft extending through the housing, and a second transmission member sleeved fixedly on one end of the output shaft and having a second bevel gear portion meshing with the first bevel gear portions of the first transmission members. When the input shaft is driven to rotate in a first or second rotational direction, the second transmission member and the output shaft are driven by one or the other of the first transmission members to rotate in an output rotational direction. An energy conversion device having the transmission mechanism is also disclosed.

### CROSS-REFERENCE TO RELATED APPLICATION

This application claims priority to Taiwanese Invention Patent Application No. 111148760, filed on Dec. 19, 2022.

### FIELD

The disclosure relates to a transmission mechanism and an energy conversion device having the same.

### BACKGROUND

An existing energy conversion device is generally used for converting mechanical energy into electrical energy. For example, a linear reciprocating motion at an input end is converted into a rotary motion for output through a transmission mechanism, and the output can drive a generator to rotate and generate electricity. However, the existing energy conversion device can only drive the generator to rotate in a single direction to generate electricity, because once the direction is changed, the rotation direction of the output end will also change accordingly, and it cannot directly and effectively drive the generator to generate electricity. Hence, there is still room for improvement of the existing energy conversion device.

### SUMMARY

Therefore, an object of the present disclosure is to provide a transmission mechanism that can alleviate at least one of the drawbacks of the prior art.

According to one aspect of this disclosure, the transmission mechanism includes a housing, an input unit and an output unit. The input unit includes an input shaft extending through the housing, an input gear fixed to one end of the input shaft and located externally of the housing, and two first transmission members rotatably sleeved on the input shaft and located in the housing in a spaced apart manner. Each first transmission member has a first bevel gear portion. The output unit includes an output shaft extending through the housing and transverse to the input shaft, and a second transmission member sleeved fixedly on one end of the output shaft and located in the housing. The second transmission member has a second bevel gear portion meshing with the first bevel gear portions of the first transmission members.

When the input shaft is driven to rotate in a first rotational direction, one of the first transmission members is driven by the input shaft to rotate therewith in the first rotational direction, while the other one of the first transmission members is in an idle state. The second transmission member and the output shaft are driven by the one of the first transmission members to rotate in an output rotational direction and to drive the other one of the first transmission members to rotate in a second rotational direction opposite to the first rotational direction. When the input shaft is driven to rotate in the second rotational direction, the other one of the first transmission members is driven by the input shaft to rotate therewith in the second rotational direction, while the one of the first transmission members is in an idle state. The second transmission member and the output shaft are driven by the other one of the first transmission members to also rotate in the output rotational direction.

Another object of the present disclosure is to provide an energy conversion device having the aforesaid transmission mechanism that can alleviate at least one of the drawbacks of the prior art.

According to another aspect of this disclosure, the energy conversion device comprises a transmission mechanism, a drive member, a speed reducer and a generator. The transmission mechanism includes a housing, an input unit and an output unit. The input unit includes an input shaft extending through the housing, an input gear fixed to one end of the input shaft and located externally of the housing, and two first transmission members rotatably sleeved on the input shaft and located in the housing in a spaced apart manner. Each first transmission member has a first bevel gear portion. The output unit includes an output shaft extending through the housing and transverse to the input shaft, and a second transmission member sleeved fixedly on one end of the output shaft and located in the housing. The second transmission member has a second bevel gear portion meshing with the first bevel gear portions of the first transmission members.

The drive member meshes with the input gear. When the input shaft is driven by the drive member to rotate in a first rotational direction, one of the first transmission members is driven by the input shaft to rotate therewith in the first rotational direction, while the other one of the first transmission members is in an idle state. The second transmission member and the output shaft are driven by the one of the first transmission members to rotate in an output rotational direction and to drive the other one of the first transmission members to rotate in a second rotational direction opposite to the first rotational direction. When the input shaft is driven by the drive member to rotate in the second rotational direction, the other one of the first transmission members is driven by the input shaft to rotate therewith in the second rotational direction, while the one of the first transmission members is in an idle state. The second transmission member and the output shaft are driven by the other one of the first transmission members to also rotate in the output rotational direction.

The speed reducer is connected to the output unit. The generator is connected to the speed reducer, and is drivable by the output unit through the speed reducer to activate and generate electricity.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a fragmentary perspective view of an energy conversion device according to an embodiment of the present disclosure.

FIG. 2 is an exploded perspective view of FIG. 1.

FIG. 3 is an exploded perspective view of a transmission mechanism of the embodiment.

FIG. 4 is a fragmentary perspective view of an assembly of the transmission mechanism and a drive member of the embodiment with a top cover of a housing of the transmission mechanism being removed for the sake of clarity.

FIG. 5 is a view similar to FIG. 4, but illustrating how an input shaft is driven by the drive member to rotate in a second rotational direction.

### DETAILED DESCRIPTION

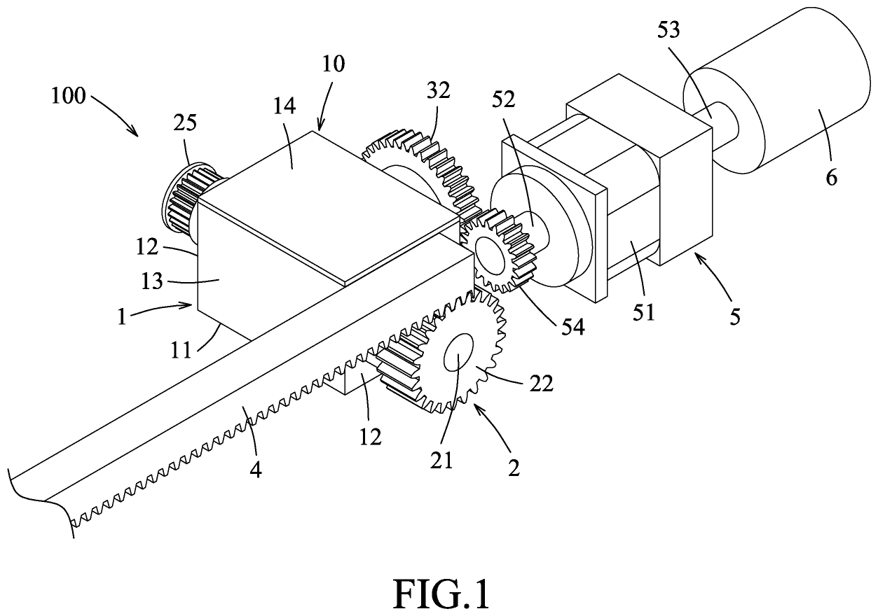

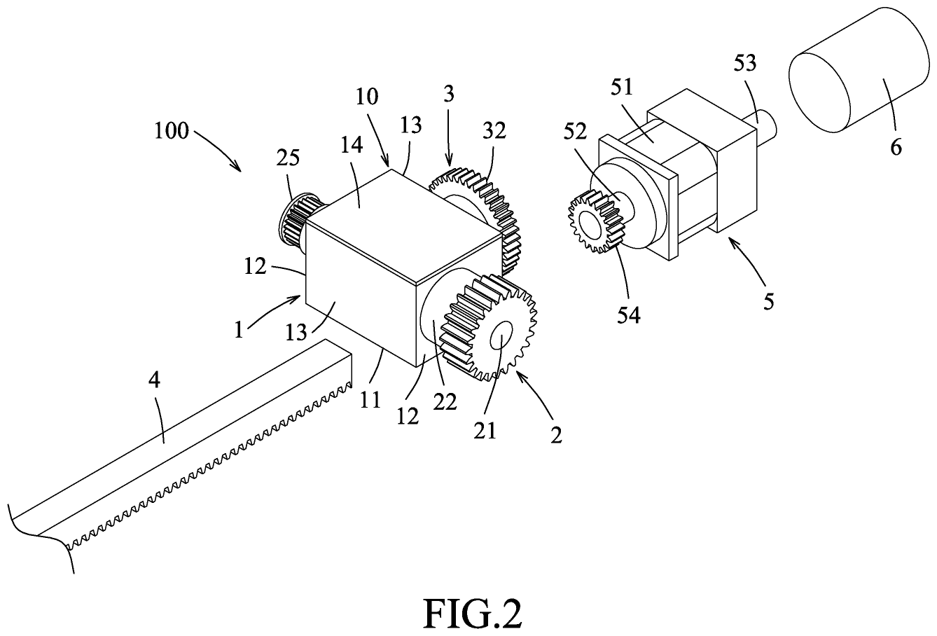

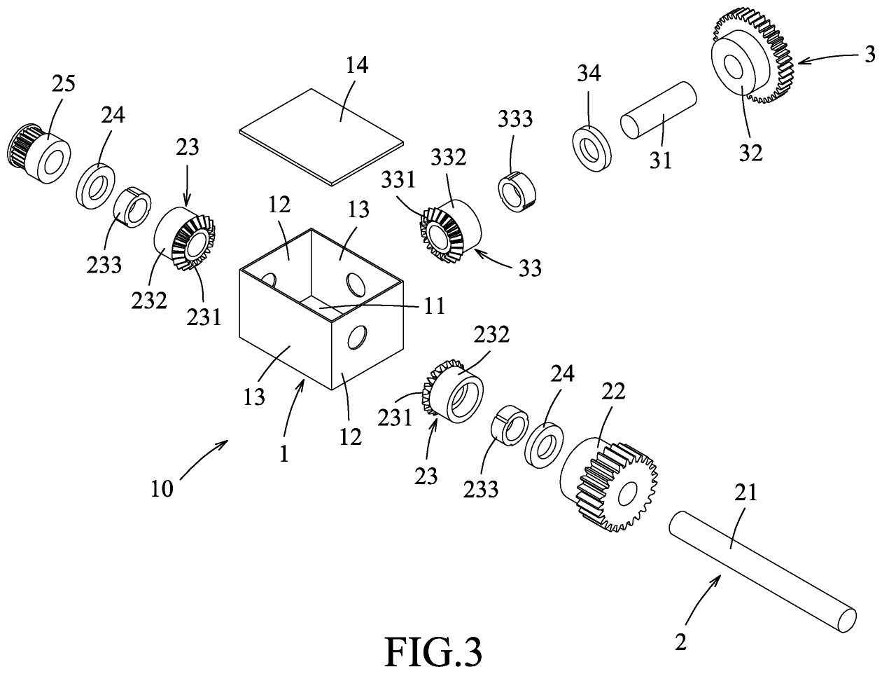

Referring to FIGS. 1 to 3, an energy conversion device 100 according to an embodiment of the present disclosure is suitable to be disposed on a shock absorber (not shown) of a motorcycle, and includes a transmission mechanism 10, a drive member 4, a speed reducer 5, and a generator 6.

The transmission mechanism 10 includes a housing 1, an input unit 2 and an output unit 3. The housing 1 includes a bottom wall 11, two first sidewalls 12 connected to and extending upwardly from two opposite ends of the bottom wall 11, two second sidewalls 13 connected to and extending upwardly from the other two opposite ends of the bottom wall 11 and connected between the first sidewalls 12, and a top cover 14 connected to top ends of the first and second sidewalls 12, 13. A length of each first sidewall 12 is shorter than that of each second sidewall 13.

The input unit 2 includes an input shaft 21 extending through the first sidewalls 12, an input gear 22 fixed to one end of the input shaft 21 and located externally of the housing 1, two first transmission members 23 rotatably sleeved on the input shaft 21 and located in the housing 1 in a spaced apart manner, two input spacers 24 sleeved on the input shaft 21, and an input shaft sleeve 25 fixed to the other end of the input shaft 21 and located externally of the housing 1. The input gear 22 may, for example, be a spur gear. Each first transmission member 23 has a first bevel gear portion 231, a first tubular sleeve portion 232 connected to the first bevel gear portion 231, and a first one-way bearing 233 sleeved on the input shaft 21 and disposed in the first tubular sleeve portion 232. Each input spacer 24 abuts between one of the first transmission members 23 and a corresponding one of the first sidewalls 12 to prevent each first transmission member 23 from moving axially along the input shaft 21. The input shaft sleeve 25 abuts against the other one of the first sidewalls 12 to prevent the input shaft 21 from moving axially relative to the housing 1.

The output unit 3 includes an output shaft 31 extending through one of the second sidewalls 13, an output gear 32 fixed to one end of the output shaft 31 and located externally of the housing 1, a second transmission member 33 sleeved fixedly on the other end of the output shaft 31 and located in the housing 1, and an output spacer 34 sleeved on the output shaft 31 and abutting between the second transmission member 33 and the one of the second sidewalls 13. An extending direction of the output shaft 31 is perpendicular to an extending direction of the input shaft 21. The output gear 32 may, for example, be a spur gear. The second transmission member 33 has a second bevel gear portion 331 meshing with the first bevel gear portions 231 of the first transmission members 23, a second tubular sleeve portion 332 connected to the second bevel gear portion 331, and a second one-way bearing 333 sleeved on the output shaft 31 and disposed in the second tubular sleeve portion 332. The output spacer 34 is provided to prevent the second transmission member 33 from moving axially along the output shaft 31.

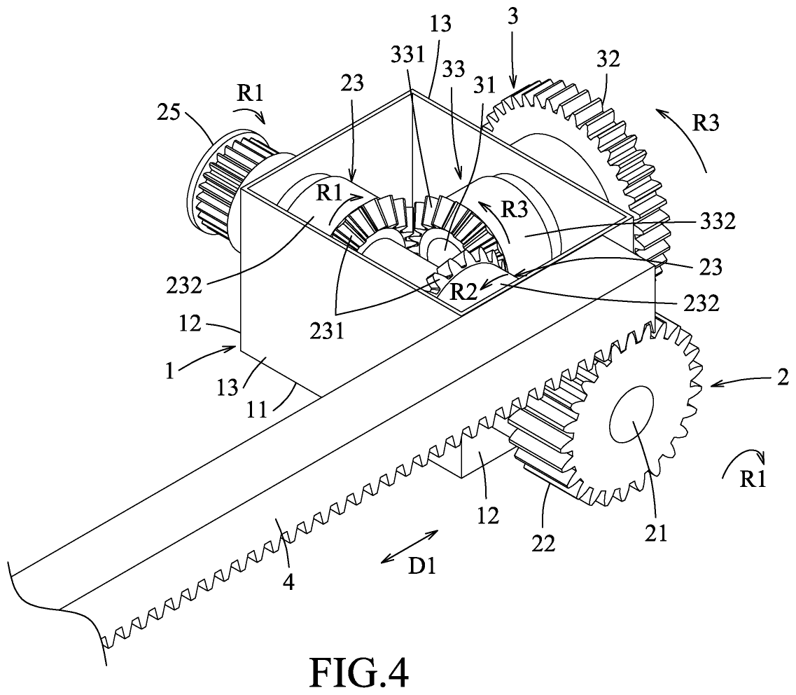

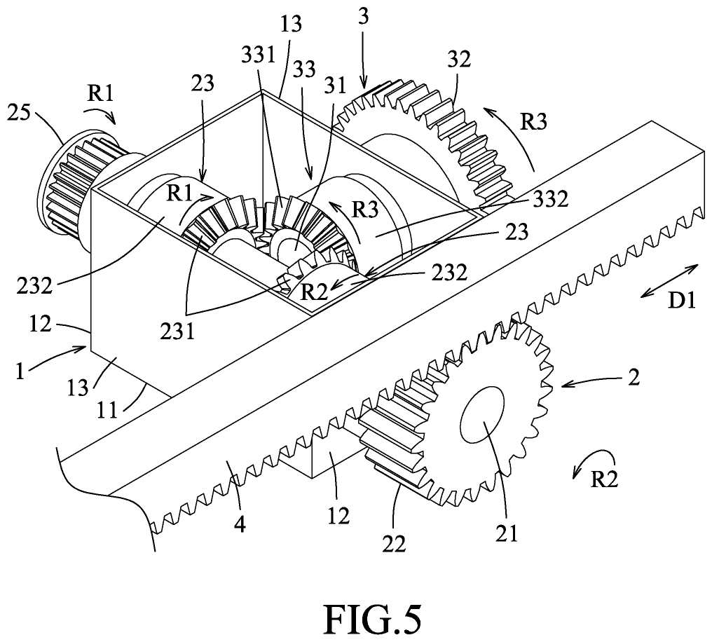

Referring to FIGS. 4 and 5, the drive member 4 of this embodiment is exemplified as a gear rack disposed on the shock absorber (not shown) of the motorcycle, but not limited thereto. The drive member 4 meshes with the input gear 22. The speed reducer 5 is connected to the output unit 3, and includes a main body 51, a speed reducer input shaft 52 connected to one end of the main body 51, a speed reducer output shaft 53 connected to the other end of the main body 51 and opposite to the speed reducer input shaft 52, and a speed reducer gear 54 sleeved fixedly on one end of the speed reducer input shaft 52 and meshing with the output gear 32. The generator 6 is connected to the speed reducer output shaft 53.

When the motorcycle is running, the shock absorber will move up and down as the motorcycle travels over a bumpy road surface, and drive the drive member 4 to displace relative to the input gear 22 along a length direction (D1). When the shock absorber moves upward, the drive member 4 is displaced toward the upper right of FIG. 4, and drives the input gear 22 and the input shaft 21 to rotate in a first rotational direction (R1). At this time, one of the first transmission members 23 is driven by the input shaft 21 to rotate therewith in the first rotational direction (R1). Because the first one-way bearing 233 of the one of the transmission members 23 is driven by the input shaft 21 to rotate therewith only when the input shaft 21 rotates in the first rotational direction (R1), while the first one-way bearing 233 of the other first transmission member 23 is driven by the input shaft 21 to rotate therewith only when the input shaft 21 rotates in a second rotational direction (R2) opposite to the first rotational direction (R1), and since the input shaft 21 is rotated in the first rotational direction (R1), the first one-way bearing 233 of the other first transmission member 23 is in an idle state at this time. In this way, the one of the first transmission members 23 can drive the second transmission member 33 and the output shaft 31 to rotate in an output rotational direction (R3), which in turn drive the other first transmission member 23 (in idle) to rotate in the second rotational direction (R2), as shown in FIG. 4. The generator 6 can then be driven by the output unit 3 through the speed reducer 5 to activate and generate electricity.

When the shock absorber moves downward, the drive member 4 is displaced toward the lower left of FIG. 5, and drives the input gear 22 and the input shaft 21 to rotate in the second rotational direction (R2). At this time, the other first transmission member 23 is driven by the input shaft 21 to rotate therewith in the second rotational direction (R2), while the one of the first transmission members 23 is in an idle state. In this way, the other first transmission member 23 can drive the second transmission member 33 and the output shaft 31 to rotate in the output rotational direction (R3), which in turn drive the one of the first transmission members 23 (in idle) to rotate in the first rotational direction (R1), as shown in FIG. 5. The generator 6 can then be driven by the output unit 3 through the speed reducer 5 to activate and generate electricity. It can be seen from this that regardless of whether the input shaft 21 rotates clockwise or counterclockwise, it can drive the output shaft 31 to rotate in the same output rotational direction (R3), and can stably output mechanical energy to the generator 6 to generate electricity. The generated electricity can charge the battery (not shown) of the motorcycle, prolonging the service life of the battery.

For easy understanding, the aforementioned “one of the first transmission members 23” refers to the first transmission member 23 that is close to the input shaft sleeve 25, while “the other first transmission member 23” refers to the first transmission member 23 that is close to the input gear 22. However, the configuration is not limited thereto, and it may also be reversed in other embodiments, and the principle is the same. It should be noted that, in this embodiment, the structure of the second transmission member 33 is basically the same as that of the first transmission member 23, but not limited thereto. In other embodiments, the second one-way bearing 333 of the second transmission member 33 may be omitted, and, in this case, the second tubular sleeve portion 332 is sleeved fixedly on the output shaft 31, so that the second transmission member 33 can move together with the output shaft 31.

It should be noted that, in other embodiments, the input shaft sleeve 25 may be omitted, and a bearing may be used instead to fix the other end of the input shaft 21 to the other one of the first sidewalls 12. In another embodiment, the input shaft sleeve 25 may be replaced by another input gear 22, and the drive member 4 may be correspondingly changed into a fork-shaped gear rack to drive the two input gears 22 synchronously. The configuration of the drive member 4 is not limited to the gear rack, and in other embodiments, the drive member 4 may be a gear belt, as long as the input gear 22 can be driven to rotate in a reciprocating manner, any form thereof is acceptable. Still in other embodiments, the output gear 32 may be omitted, and, in this case, the output shaft 31 is directly connected to the speed reducer input shaft 52. The only difference with this embodiment is that the rotation direction of the speed reducer input shaft 52 is the same as the output rotational direction (R3), whereas the rotation direction of the speed reducer input shaft 52 of this embodiment is opposite to the output rotational direction (R3).

In summary, through the dispositions of the first transmission members 23 and the second transmission member 33 of the transmission mechanism 10 of the energy conversion device 100, when the input shaft 21 is driven to rotate in the first rotational direction (R1), the input shaft 21 can drive the second transmission member 33 and the output shaft 31 to rotate in the output rotational direction (R3), which in turn, drive the other first transmission member 23 to rotate in the second rotational direction (R2) opposite to the first rotational direction (R1); and, when the input shaft 21 is driven to rotate in the second rotational direction (R2), the input shaft 21 can similarly drive the second transmission member 33 and the output shaft 31 to rotate in the output rotational direction (R3). That is, regardless of whether the input shaft 21 rotates clockwise or counterclockwise, it can drive the output shaft 31 to rotate in the same output rotational direction (R3), and can stably output mechanical energy to the generator 6 to generate electricity. Therefore, the object of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A transmission mechanism, comprising:
a housing;
an input unit including an input shaft extending through said housing, an input gear fixed to one end of said input shaft and located externally of said housing, and two first transmission members rotatably sleeved on said input shaft and located in said housing in a spaced apart manner, each of said first transmission members having a first bevel gear portion; and
an output unit including an output shaft extending through said housing and transverse to said input shaft, and a second transmission member sleeved fixedly on one end of said output shaft and located in said housing, said second transmission member having a second bevel gear portion meshing with said first bevel gear portions of said first transmission members;
wherein, when said input shaft is driven to rotate in a first rotational direction, one of said first transmission members is driven by said input shaft to rotate therewith in said first rotational direction, while the other one of said first transmission members is in an idle state, and said second transmission member and said output shaft are driven by said one of said first transmission members to rotate in an output rotational direction and to drive said other one of said first transmission members to rotate in a second rotational direction opposite to said first rotational direction; and
wherein, when said input shaft is driven to rotate in said second rotational direction, said other one of said first transmission members is driven by said input shaft to rotate therewith in said second rotational direction, while said one of said first transmission members is in an idle state, and said second transmission member and said output shaft are driven by said other one of said first transmission members to also rotate in said output rotational direction.

2. The transmission mechanism as claimed in claim 1, wherein each of said first transmission members further has a first tubular sleeve portion connected to said first bevel gear portion, and a first one-way bearing sleeved on said input shaft and disposed in said first tubular sleeve portion.

3. The transmission mechanism as claimed in claim 1, wherein said second transmission member further has a second tubular sleeve portion connected to said second bevel gear portion, and a second one-way bearing sleeved on said output shaft and disposed in said second tubular sleeve portion.

4. The transmission mechanism as claimed in claim 1, wherein said housing includes a bottom wall, two first sidewalls connected to and extending upwardly from two opposite ends of said bottom wall, and two second sidewalls connected to and extending upwardly from the other two opposite ends of said bottom wall and connected between said first sidewalls, said first sidewalls being configured for extension of said input shaft therethrough, one of said second sidewalls being configured for extension of said output shaft therethrough.

5. The transmission mechanism as claimed in claim 4, wherein said output unit further includes an output gear fixed to the other end of said output shaft and located externally of said housing, and an output spacer sleeved on said output shaft and abutting between said second transmission member and said one of said second sidewalls; and, wherein said input unit further includes an input shaft sleeve fixed to the other end of said input shaft and located externally of said housing, and two input spacers sleeved on said input shaft, each of said input spacers abutting between one of said first transmission members and a corresponding one of said first sidewalls.

6. The transmission mechanism as claimed in claim 5, wherein said one of said first transmission members is close to said input shaft sleeve, while said other one of said first transmission members is close to said input gear.

7. An energy conversion device, comprising:
a transmission mechanism including a housing, an input unit and an output unit, said input unit including an input shaft extending through said housing, an input gear fixed to one end of said input shaft and located externally of said housing, and two first transmission members rotatably sleeved on said input shaft and located in said housing in a spaced apart manner, each of said first transmission members having a first bevel gear portion, said output unit including an output shaft extending through said housing and transverse to said input shaft, and a second transmission member sleeved fixedly on one end of said output shaft and located in said housing, said second transmission member having a second bevel gear portion meshing with said first bevel gear portions of said first transmission members;
a drive member meshing with said input gear, wherein, when said input shaft is driven by said drive member to rotate in a first rotational direction, one of said first transmission members is driven by said input shaft to rotate therewith in said first rotational direction, while the other one of said first transmission members is in an idle state, and said second transmission member and said output shaft are driven by said one of said first transmission members to rotate in an output rotational direction and to drive said other one of said first transmission members to rotate in a second rotational direction opposite to said first rotational direction; and wherein, when said input shaft is driven by said drive member to rotate in said second rotational direction, said other one of said first transmission members is driven by said input shaft to rotate therewith in said second rotational direction, while said one of said first transmission members is in an idle state, and said second transmission member and said output shaft are driven by said other one of said first transmission members to also rotate in said output rotational direction;
a speed reducer connected to said output unit; and
a generator connected to said speed reducer, said generator being drivable by said output unit through said speed reducer to activate and generate electricity.

8. The energy conversion device as claimed in claim 7, wherein each of said first transmission members further has a first tubular sleeve portion connected to said first bevel gear portion, and a first one-way bearing sleeved on said input shaft and disposed in said first tubular sleeve portion.

9. The energy conversion device as claimed in claim 7, wherein said second transmission member further has a second tubular sleeve portion connected to said second bevel gear portion, and a second one-way bearing sleeved on said output shaft and disposed in said second tubular sleeve portion.

10. The energy conversion device as claimed in claim 7, wherein said housing includes a bottom wall, two first sidewalls connected to and extending upwardly from two opposite ends of said bottom wall, and two second sidewalls connected to and extending upwardly from the other two opposite ends of said bottom wall and connected between said first sidewalls, said first sidewalls being configured for extension of said input shaft therethrough, one of said second sidewalls being configured for extension of said output shaft therethrough.

11. The energy conversion device as claimed in claim 10, wherein said output unit further includes an output gear fixed to the other end of said output shaft and located externally of said housing, and an output spacer sleeved on said output shaft and abutting between said second transmission member and said one of said second sidewalls; wherein said speed reducer includes a main body, a speed reducer input shaft connected to said main body, and a speed reducer gear sleeved fixedly on one end of said speed reducer input shaft and meshing with said output gear; and, wherein said input unit further includes an input shaft sleeve fixed to the other end of said input shaft and located externally of said housing, and two input spacers sleeved on said input shaft, each of said input spacers abutting between one of said first transmission members and a corresponding one of said first sidewalls.

12. The energy conversion device as claimed in claim 11, wherein said one of said first transmission members is close to said input shaft sleeve, while said other one of said first transmission members is close to said input gear.
